(19) United States
(12) Patent Application Publication
(10) Pub. No.: US 2026/0356137 A1
(43) Pub. Date: Nov. 12, 2026

(54) Vehicle Wheel Sensing Apparatus that Automatically Detects and Calibrates Its Position on a Vehicle

(71) Applicant: MONLIZ LLC, Sacramento, CA (US)

(72) Inventors: Lee Lizarraga, Ventura, CA (US); Steven A. Tobenkin, Las Vegas, NV (US); Robert Monaghan, Ventura, CA (US)

(73) Assignee: MONLIZ LLC, Sacramento, CA (US)

(21) Appl. No.: 19/201,090

(22) Filed: May 7, 2025

(51) Int. Cl. B60C 23/04; G01C 22/00

(52) U.S. Cl. CPC B60C 23/0416; B60C 23/0433; G01C 22/00

(57) ABSTRACT

A vehicle wheel sensor apparatus automatically detects and calibrates its position on a vehicle without human input and generates various measurements that are correctly attributed to the automatically detected wheel position. The apparatus exchanges wireless signaling with other apparatuses that are integrated in different wheels of the vehicle, and determines its relative position on the vehicle based on different directions or different distances that are measured from the wireless signaling received from the apparatuses. The apparatus determines its exact position based on the relative position and an additional input that identifies a front of the vehicle, obtains a measurement of the wheel that is monitored by apparatus, and updates the vehicle's monitoring system with the exact position and the measurement that is obtained at that exact position.

### BACKGROUND

Vehicle wheels may come with integrated tire pressure sensors. The tire pressure sensors monitor tire pressure and wirelessly report the pressure readings to the tire pressure monitoring system (TPMS) of the vehicle. The TPMS may provide alerts or present the tire pressure measurements on the vehicle dashboard or infotainment system. For instance, the vehicle dashboard may present the measured tire pressure at the position of each wheel or may provide an alert to specify which of the vehicle wheels is overinflated or underinflated.

Tire rotations are performed periodically to maximize the life of the tires. Tire rotations involve changing the tire positions on the vehicle so that the tire tread (e.g., outside and inside of the tire) is evenly worn over time.

After the wheels are physically rotated to their new positions, the mechanic must manually update the TPMS to specify the new tire positions. The manual updating includes connecting a computer or other service device to the vehicle, and providing the updated tire positions to the vehicle so that the vehicle TPMS accurately reports the tire pressure at the correct positions. For instance, the TPMS may be calibrated to present the tire pressure from a tire pressure sensor with a particular identifier at the front left position where the tire is initially located. After a tire rotation, the tire may be moved to the back right position. Without updating the TPMS, the TPMS will continue to report the readings associated with the particular identifier at the front left position even though the tire is rotated to the back right position. Oftentimes, mechanics do not manually update the TPMS after a tire rotation because of time, cost, or improper training regarding the need to manually update the TPMS.

### BRIEF DESCRIPTION OF THE DRAWINGS

FIG. 1 illustrates an example of automatically detecting and calibrating wheel positions using the vehicle wheel sensor apparatuses in accordance with some embodiments presented herein.

FIG. 2 illustrates an example of a vehicle wheel sensor apparatus in accordance with some embodiments presented herein.

FIG. 3 illustrates an example of vehicle wheel sensor apparatuses obtaining input from a user device in order to automatically detect and calibrate the wheel positions in accordance with some embodiments presented herein.

FIG. 4 presents a process for performing the automatic detection and calibration of wheel position with a vehicle monitoring system in accordance with some embodiments.

FIG. 5 illustrates an example of automatically tracking vehicle maintenance using the vehicle wheel sensor apparatuses in accordance with some embodiments presented herein.

FIG. 6 illustrates an example of providing service reminders based on the tracking performed by the vehicle wheel sensor apparatuses in accordance with some embodiments presented herein.

FIG. 7 illustrates an example of performing a zero-configuration wheel alignment using the vehicle wheel sensor apparatuses in accordance with some embodiments presented herein.

FIG. 8 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided is a vehicle wheel sensor apparatus that automatically detects and calibrates its position on a vehicle without human input and that generates various measurements that are correctly attributed to the automatically detected wheel position. The vehicle wheel sensor apparatus exchanges wireless signaling with other vehicle wheel sensor apparatuses that are integrated or mounted on other wheels of the same vehicle to determine relative positions of each vehicle wheel sensor apparatus on the vehicle. Additional inputs that are automatically generated by the vehicle wheel sensor apparatuses from the motion of the vehicle or turning of the wheels may be used to fully calibrate the vehicle wheel positions and automatically update the tire pressure monitoring system (TPMS) or other monitoring system of the vehicle with the correct position of each vehicle when sensor apparatus and the corresponding wheel or tire. In some embodiments, the additional inputs may be received from a user device that is located at or that differentiates the front of the vehicle from the back of the vehicle.

The vehicle wheel sensor apparatuses detect the tire rotations, automatically calibrate a monitoring system of the vehicle with the updated positions, measure various properties associated with the tires, wheels, and/or driving characteristics of the vehicle, generate maintenance notifications on the vehicle dashboard or to a user device as various wheel, tire, or vehicle maintenance comes due based on the measured properties, provide tire warranty verification, and facilitate a zero-configuration wheel alignment. In this manner, the vehicle wheel sensor apparatuses improve vehicle safety and automatically track new data points over the vehicle history. As such, the vehicle wheel sensor apparatuses offer important insights and measurements to the vehicle owner, repair facility, tire manufacturer, and/or vehicle manufacturer that were previously not available in such an automated fashion.

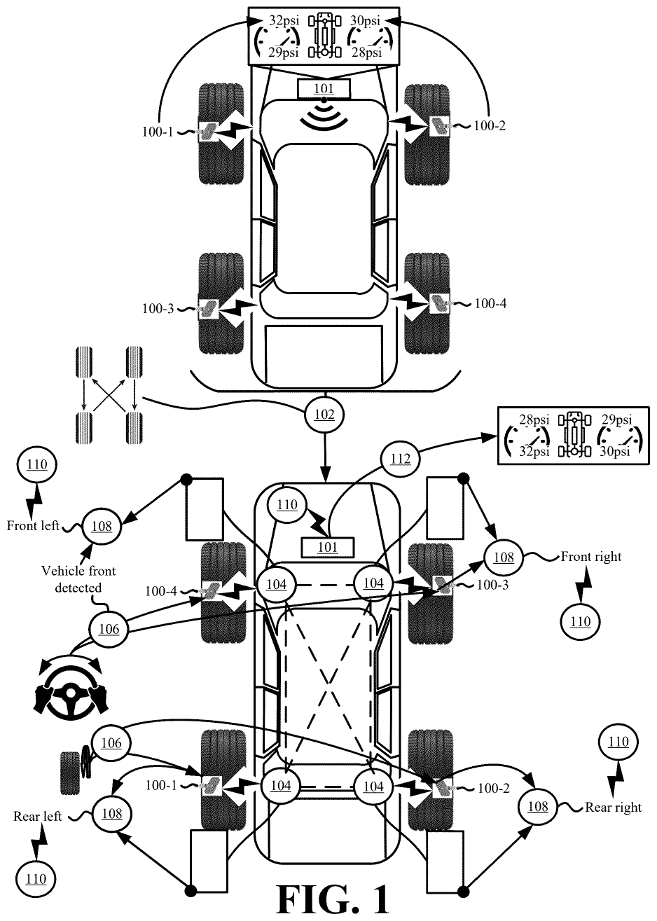

FIG. 1 illustrates an example of automatically detecting and calibrating wheel positions using the vehicle wheel sensor apparatuses in accordance with some embodiments presented herein. Vehicle wheel sensor apparatus 100-1 is integrated in the front left wheel of the vehicle, vehicle wheel sensor apparatus 100-2 is integrated in the front right wheel of the vehicle, vehicle wheel sensor apparatus 100-3 is integrated in the rear left wheel of the vehicle, and vehicle wheel sensor apparatus 100-4 is integrated in the rear right wheel of the vehicle. Vehicle wheel sensor apparatuses 100-1, 100-2, 100-3, and 100-4 may be collectively referred as to vehicle wheel sensor apparatuses 100 or individually as vehicle wheel sensor apparatus 100.

Each vehicle wheel sensor apparatus 100 is assigned and identifies itself with a unique identifier. The unique identifier may correspond to a Media Access Control (MAC) address or other unique value that is hardcoded or stored in the memory of that vehicle wheel sensor apparatus 100.

Vehicle wheel sensor apparatuses 100 exchange wireless messaging with one another and with monitoring system 101 of the vehicle. Monitoring system 101 may include the vehicle TPMS or another chip or system that the vehicle uses to collect and/or present data from various sensors including vehicle wheel sensor apparatuses 100. Vehicle wheel sensor apparatuses 100 provide their unique identifier, their position on the vehicle, a tire pressure reading, and/or other measurements to monitoring system 101.

The position of the vehicle wheels may be changed during service. For instance, a mechanic may perform (at 102) a tire rotation to swap the wheel positions.

This could cause the TPMS to present tire pressure readings at the wrong locations if the TPMS was not manually updated by the mechanic with the new wheel locations. However, vehicle wheel sensor apparatuses 100 self-calibrate based on sensor generated data.

Vehicle wheel sensor apparatuses 100 exchange Ultra-Wideband (UWB) signaling and/or other signaling from which the originating direction and distance may be determined using Time of Flight (ToF) or other techniques. Vehicle wheel sensor apparatuses 100 measure the distance and direction of the signaling from the other vehicle wheel sensor apparatuses 100 in order to determine (at 104) their relative position about the vehicle.

Vehicle wheel sensor apparatuses 100 obtain (at 106) additional inputs to determine their exact position on the vehicle. The signaling exchanged between vehicle wheel sensor apparatuses 100 is not enough to determine whether a particular wheel is at the front left or rear right position. In other words, the measured direction and distance of the exchanged signaling does not differentiate or reveal the vehicle front from the vehicle back. To make this differentiation, vehicle wheel sensor apparatuses 100 obtain (at 104) the additional inputs for determining the vehicle front by sensing which wheels turn right and/or left in response to a steering wheel rotation or by sensing the direction in which the wheels rotate at speeds that are indicative of the vehicle moving in a forward direction (e.g., over 10 miles per hour).

Vehicle wheel sensor apparatuses 100 apply the additional inputs and/or the location of the vehicle front to the determined relative position in order to automatically detect (at 108) their exact position on the vehicle. Vehicle wheel sensor apparatuses 100 wirelessly transmit (at 110) their exact position with their unique identifier and/or other measurements (e.g., tire pressure measurement) to monitoring system 101.

Monitoring system 101 receives (at 110) the exact position and the unique identifier from each vehicle wheel sensor apparatus 100, and automatically updates (at 112) displays and/or measurements logs based on the exact wheel position that is provided with any accompanying measurements from vehicle wheel sensor apparatuses 100. For instance, monitoring system 101 automatically recalibrates and updates (at 112) a tire pressure display to present the tire pressure measurements obtained from vehicle wheel sensor apparatuses 100 at the correct wheel positions identified by vehicle wheel sensor apparatuses 100.

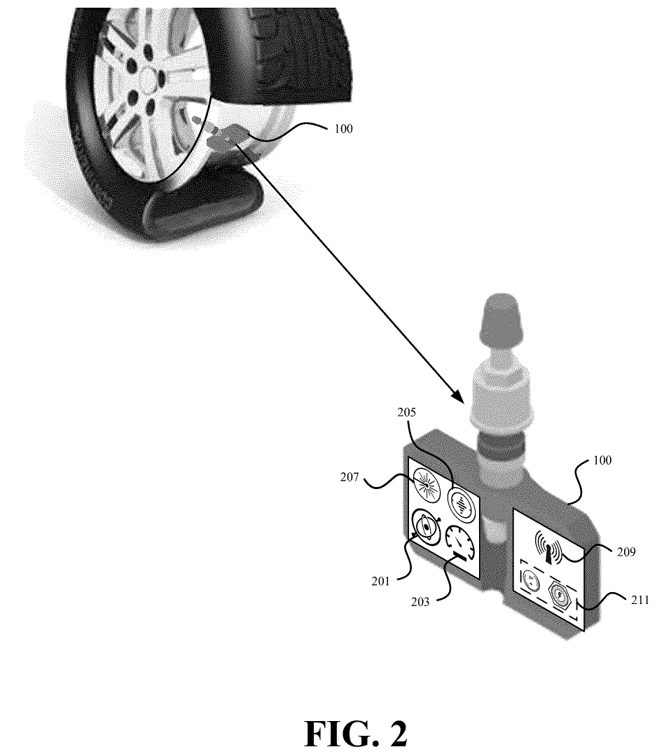

FIG. 2 illustrates an example of vehicle wheel sensor apparatus 100 in accordance with some embodiments presented herein. As shown, vehicle wheel sensor apparatus 100 may be integrated as part of the tire strainer valve. Vehicle wheel sensor apparatus 100 may be mounted, attached, or otherwise coupled to the tire strainer valve in a similar fashion as a tire pressure monitoring sensor. For instance, the tire strainer valve nozzle extends through an opening in the wheel rim with the sensors of vehicle wheel sensor apparatus 100 being disposed between the rim and the tire that is placed over the rim. In some embodiments, vehicle wheel sensor apparatus 100 is mounted or attached to the inside of the wheel rim (e.g., the wheel inner barrel). For instance, vehicle wheel sensor apparatus 100 may be adhered, screwed, or strapped to the inner wheel rim. In some other embodiments, vehicle wheel sensor apparatus 100 is an apparatus that mounts or is attached to the outside of the vehicle mount via a clamp or other attachment means. For instance, vehicle wheel sensor apparatus 100 may be mounted to the rim via a bracket to perform specific maintenance (e.g., wheel alignment).

In some embodiments, vehicle wheel sensor apparatus 100 includes a tire pressure sensor. In some other embodiments, vehicle wheel sensor apparatus 100 excludes or replaces the tire pressure sensor that previously was integrated in the tire or wheel. Vehicle wheel sensor apparatus 100 may further include one or more of inertial measurement unit (“IMU”) 201, accelerometer 203, gyroscope 205, other sensors 207 and/or integrated circuits for measuring the wheel's arc-of-rotation, acceleration, angular velocity, angle, orientation, height, and position while in motion, transceiver 209, and power unit 211.

Unlike the tire pressure sensor which generates a single measurement for a single vehicle component (e.g., the tire pressure), vehicle wheel sensor apparatus 100 generates multiple measurements for different driving characteristics of the vehicle. For instance, vehicle wheel sensor apparatus 100 may generate measurements for the rotation, orientation, and/or positioning of the vehicle wheels and tires.

Moreover, traditional tire pressure sensors may include a Radio Frequency Identification (RFID) tag and a transmitter for wirelessly broadcasting the tire pressure readings with the RFID tag to the TPMS without any information as to the position of the wheel or tire associated with the tire pressure readings. The TPMS is manually configured to associate the RFID tag with a particular position. When the wheel position changes due to a tire rotation or other maintenance and the TPMS is not reconfigured or calibrated with the new wheel position, the TPMS will incorrectly track, present, and report the tire pressure associated with the RFID tag at the old wheel position configured for that RFID tag. Vehicle wheel sensor apparatus 100 uses ToF, time difference of arrival, multilateration, triangulation, other positional signaling, and/or other sensor measurements to determine the relative and exact position of vehicle wheel sensor apparatus 100 about the vehicle (e.g., front left, front right, rear left, or rear right) and to automatically update the TPMS or other monitoring system 101 of the vehicle with the obtained measurements at the correct wheel position.

IMU 201 may measure acceleration, orientation, angular rates, and other gravitational forces of a wheel or tire mounted on the wheel. In some embodiments, accelerometer 203 and/or gyroscope 205 control the sampling rate of IMU 201. For instance, accelerometer 203 and/or gyroscope 205 may track the position of vehicle wheel sensor apparatus 100 relative to the wheel or road (e.g., at the bottom, bottom left, bottom right, top, etc. of the wheel) as the wheel rotates with the vehicle in motion, and may control IMU 201 in taking measurements when IMU 201 or vehicle wheel sensor apparatus 100 moves to the same set of positions (e.g., bottom left, bottom right, and top) during every wheel rotation. Accordingly, vehicle wheel sensor apparatus 100 may generate measurements that may be compared to one another, and that may be used to determine different loads on the wheels, calculate wear on the tires, changes in wheel alignment, and/or other driving characteristics.

Transceiver 209 may include a Bluetooth, Bluetooth Low Energy, UWB, or other low-power or short-range radio for communicating or exchanging signaling with monitoring system 101 and/or other nearby vehicle wheel sensor apparatuses 100, for transferring data to monitoring system 101, and/or for receiving commands or configuration data from monitoring system 101. Transceiver 209 or vehicle wheel sensor apparatus 100 may include one or more processors for measuring the distance and direction of signaling that is received from other vehicle wheel sensor apparatuses 100 based on the signaling characteristics or properties. The processor may use ToF, time difference of arrival, multilateration, triangulation, other techniques to determine the distance and direction of the transmitter for a received signal based on the characteristics or properties of the received signal. In some embodiments, transceiver 209 may be used to directly offload the data from vehicle wheel sensor apparatus 100 to a user device such as a smartphone, tablet, or other wireless computing device.

Power unit 211 may include a battery that continuously or selectively powers vehicle wheel sensor apparatus 100. For instance, power unit 211 may power accelerometer 203 when the vehicle is not moving, and may power all sensors once accelerometer 203 determines that the vehicle is in motion. In some embodiments, power unit 211 may include a rotational power generator (e.g., magnets) that generates power from the rotation of the vehicle wheel in a quantity that is sufficient to power the sensors and other components of vehicle wheel sensor apparatus 100 even with the vehicle moving at low speeds (e.g., 2 or more miles per hour). In some embodiments, power unit 211 may include a piezoelectric power generator or a centripetal power generator that powers vehicle wheel sensor apparatus 100 components based on electricity that is generated during the rotation of the wheel.

Vehicle wheel sensor apparatus 100 may include a protective housing to protect the sensors and other components from environmental elements and/or shocks resulting from the vehicle driving on uneven roads at different various speeds. In some embodiments, the positioning of vehicle wheel sensor apparatus 100 within the interior of the tire on the tire strainer valve provides sufficient protection from the environmental elements.

In some embodiments, vehicle wheel sensor apparatus 100 is one or more centimeters in size and is rated to last longer than the expected life of the tire (e.g., over 7 years). In some embodiments, the sensors and other components of vehicle wheel sensor apparatus 100 are integrated onto a single printed circuit board or wafer to minimize power consumption, size, and potential for damaging the interconnects between the sensors and components.

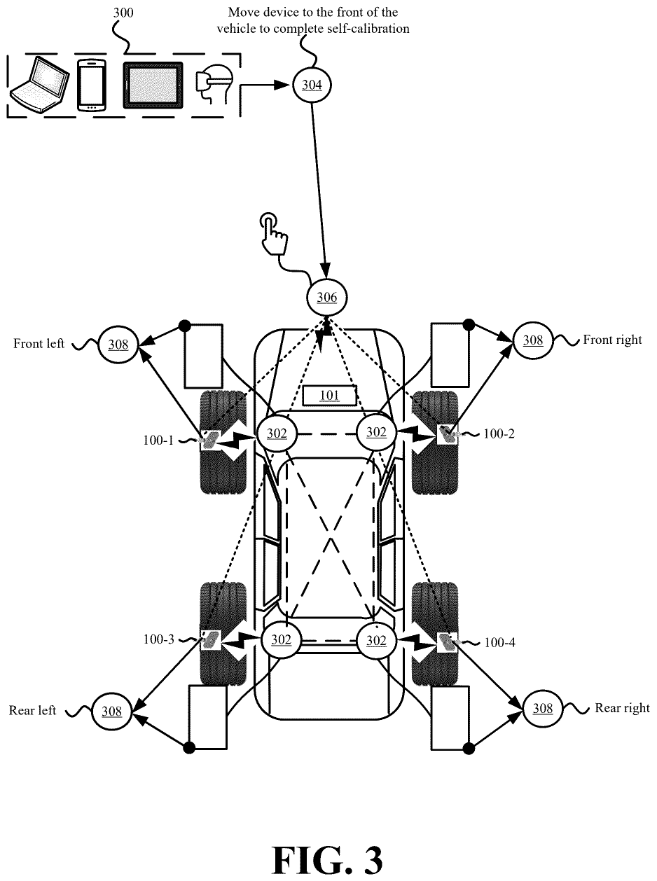

FIG. 3 illustrates an example of vehicle wheel sensor apparatuses 100 obtaining input from a user device in order to automatically detect and calibrate the wheel positions in accordance with some embodiments presented herein. Vehicle wheel sensor apparatuses 100 exchange (at 302) signaling with one another, and measure the time, angle, and/or attenuation of the signaling to determine their relative position about the vehicle.

User device 300 may temporarily couple to vehicle wheel sensor apparatuses 100 using a Bluetooth or UWB discovery or pairing procedure. In some embodiments, user device 300 may run an application that detects and pairs to vehicle wheel sensor apparatuses 100 using specific wireless frequencies and/or protocols that vehicle wheel sensor apparatuses 100 use to communicate with one another and/or monitoring system 101.

Signaling or messaging from user device 300 may identify user device 300 as a device that provides the additional input by which each vehicle wheel sensor apparatus 100 determines its exact position on the vehicle. For instance, vehicle wheel sensor apparatuses 100 may detect that user device 300 is a reference device that provides the additional input for determining the vehicle front. Once paired or coupled to vehicle wheel sensor apparatuses 100 of a particular vehicle, user device 300 may provide (at 304) the user instruction to move towards the front of the vehicle and/or press a button or provide other input to indicate when they are at the front of the vehicle. For instance, the user may press (at 306) a button, speak a command, and/or perform a gesture to indicate that they are at the front of the vehicle. In some embodiments, user device 300 may activate a camera of user device 300, perform image recognition to detect when user device 300 is moved in front of the vehicle, and automatically generate the input to indicate when user device 300 is moved in front of the vehicle.

Vehicle wheel sensor apparatuses 100 detect (at 308) their exact positions on the vehicle based on the additional input from user device 300. Specifically, vehicle wheel sensor apparatuses 100 detect their exact positions based on their positions relative to one another and relative to user device 300 once user device 300 is verified to be at the vehicle front.

Vehicle wheel sensor apparatuses 100 on the rear wheels detect their positions by determining that one or more vehicle wheel sensor apparatuses 100 are between their position and the position of user device 300 or by determining that one or more vehicle wheel sensor apparatuses 100 are in the same direction as user device 300. Vehicle wheel sensor apparatuses 100 on the front wheels detect their positions by determining user device 300 is located in an opposite direction from two vehicle wheel sensor apparatuses 100 on the rear wheels.

The left and right wheel determination is similarly based on the angle or direction of the signaling received from user device 300. If the signaling from user device 300 arrives in a first 90 degree arc (e.g., 90-180 degrees), then vehicle wheel sensor apparatus 100 may determine that it is on the left side of the vehicle, and if the signaling from user device 300 arrives in a second 90 degree arc (e.g., 180-270 degrees), then vehicle wheel sensor apparatus 100 may determine that it is on the right side of the vehicle.

Vehicle wheel sensor apparatuses 100 may report their exact positions and any measurements generated by their respective sensors to user device 300 for real-time or live viewing or to monitoring system 101. Monitoring system 101 may log the measurements at the correct wheel positions and/or may update vehicle-to-user interfaces to present the measurements at the correct wheel locations in a dashboard, infotainment, or other vehicle display.

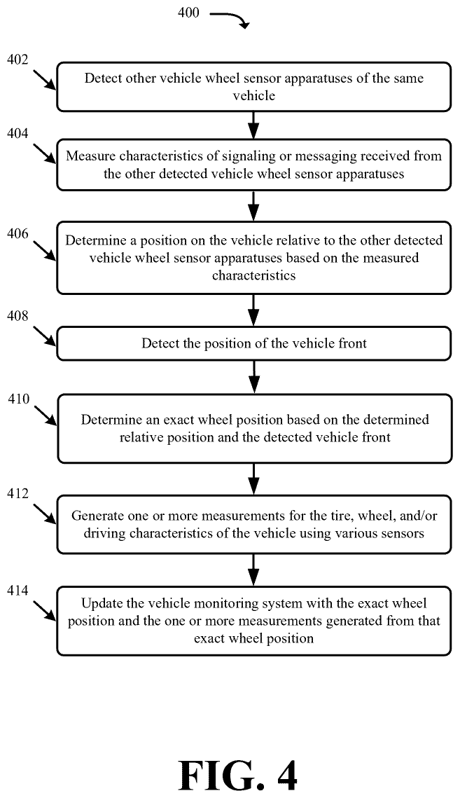

FIG. 4 presents a process 400 for performing the automatic detection and calibration of wheel position with a vehicle monitoring system in accordance with some embodiments. Process 400 is performed by each vehicle wheel sensor apparatus 100. Process 400 may be continually performed by each vehicle wheel sensor apparatus 100 or may be performed in response to a triggering condition such as the vehicle being in motion.

Process 400 includes detecting (at 402) other vehicle wheel sensor apparatuses 100 of the same vehicle. Vehicle wheel sensor apparatuses 100 may be configured to pair to one another and with monitoring system 101 of the vehicle when powered on. The range of the wireless radio or transceiver of each vehicle wheel sensor apparatus is limited to avoid detecting vehicle wheel sensor apparatus 100 of other vehicles. Each vehicle wheel sensor apparatus 100 may periodically broadcast a message that identifies that vehicle wheel sensor apparatus 100 and from which other vehicle wheel sensor apparatuses 100 on the same vehicle may be discovered.

Process 400 includes measuring (at 404) characteristics of signaling or messaging received from the other detected (at 402) vehicle wheel sensor apparatuses 100. Measuring (at 404) the characteristics may include determining the direction and distance of each vehicle wheel sensor apparatus 100 based on ToF, time difference of arrival, multilateration, triangulation, and/or other signal processing techniques for determining the direction and distance of the signal originator. In some embodiments, vehicle wheel sensor apparatuses 100 transmit UWB signaling or messages and use UWB signal processing techniques to determine the direction and distance of the transmitting apparatus.

Process 400 includes determining (at 406) a position on the vehicle relative to the other detected (at 402) vehicle wheel sensor apparatuses 100 based on the measured (at 404) characteristics. Determining (at 406) the relative position includes determining a corner of the vehicle that vehicle wheel sensor apparatus 100 is located based on the direction and distance that the signaling from the other vehicle wheel sensor apparatuses 100 arrive. For instance, if a particular vehicle wheel sensor apparatus 100 detects signaling with a first unique identifier of a first vehicle wheel sensor apparatus 100 arriving at a 270 degree angle, signaling with a second unique identifier of a second vehicle wheel sensor apparatus 100 arriving at a 225 degree angle, and signaling with a third unique identifier of a third vehicle wheel sensor apparatus 100 arriving at a 180 degree angle, then the particular vehicle wheel sensor apparatus 100 may determine that it is in a right corner of a vehicle. Similarly, if a particular vehicle wheel sensor apparatus 100 detects signaling with a first unique identifier of a first vehicle wheel sensor apparatus 100 arriving at a 90 degree angle, signaling with a second unique identifier of a second vehicle wheel sensor apparatus 100 arriving at a 0 degree angle, and signaling with a third unique identifier of a third vehicle wheel sensor apparatus 100 arriving at a 45 degree angle, then the particular vehicle wheel sensor apparatus 100 may determine that it is in a left corner of a vehicle.

Process 400 includes detecting (at 408) the position of the vehicle front. In some embodiments, the vehicle front may be detected (at 408) based on two of vehicle wheel sensor apparatuses 100 located on the vehicle front wheels measuring a side-to-side movement in response to a steering wheel rotation moving the front wheels side-to-side. The two vehicle wheel sensor apparatuses 100 may report the detected side-to-side movement to other vehicle wheel sensor apparatuses 100 and/or monitoring system 101 or may assign themselves to the front wheel positions and report the assignment to the other vehicle wheel sensor apparatuses 100 and/or monitoring system 101. In some other embodiments, the vehicle front may be detected (at 408) based on the direction with which the wheels rotate at a sufficiently high speed that represents a forward movement of the vehicle (e.g., over 10 miles per hour). In still some other embodiments, the vehicle front may be detected (at 408) based on the distance and direction of signaling or messaging received from user device 300 that is moved to the vehicle front before transmitting the signaling or messaging. If a vehicle wheel sensor apparatus 100 measures the signaling or messaging from user device 300 to arrive from an opposite 180 degree arc than the signaling or messaging from other vehicle wheel sensor apparatuses 100, then that vehicle wheel sensor apparatus 100 is located on the front wheels, and if a vehicle wheel sensor apparatus 100 measures the signaling or messaging from user device 300 to arrive in the same 180 degree arc as the signaling or messaging from other vehicle wheel sensor apparatuses 100, then that vehicle wheel sensor apparatus 100 is located on the rear wheels.

Process 400 includes determining (at 410) an exact wheel position based on the determined (at 406) relative position and the detected (at 408) vehicle front. For instance, vehicle wheel sensor apparatus 100 that is determined to be at the vehicle front and that detects two other vehicle wheel sensor apparatuses 100 in a first 90 degree arc (e.g., between 90 and 180 degrees) is determined (at 410) to be the front left wheel, vehicle wheel sensor apparatus 100 that is determined to be at the vehicle front and that detects two other vehicle wheel sensor apparatuses 100 in a second 90 degree arc (e.g., between 180 and 270 degrees) is determined (at 410) to be the front right wheel, vehicle wheel sensor apparatus 100 that is determined to be at the vehicle rear and that detects two other vehicle wheel sensor apparatuses 100 in a third 90 degree arc (e.g., between 0 and 90 degrees) is determined (at 410) to be the rear left wheel, and vehicle wheel sensor apparatus 100 that is determined to be at the vehicle rear and that detects two other vehicle wheel sensor apparatuses 100 in a fourth 90 degree arc (e.g., between 270 and 360 or 0 degrees) is determined (at 410) to be the rear right wheel.

Process 400 includes generating (at 412) one or more measurements for the tire, wheel, and/or driving characteristics of the vehicle using various sensors of vehicle wheel sensor apparatus 100 for that tire or wheel. Generating (at 412) the one or more measurements may include measuring the tire pressure, tracking wheel rotations to track mileage and/or tread wear, measuring wheel alignment (e.g., toe, camber, caster, etc.), measuring wheel vibration, etc.

Process 400 includes updating (at 414) monitoring system 101 of the vehicle with the exact wheel position and the one or more measurements generated (at 412) from that exact wheel position. Updating (at 414) monitoring system 101 includes sending wireless signaling or messaging in a specific frequency range used by monitoring system 101. For instance, the vehicle TPMS typically operates using frequencies 315 Megahertz (MHz) and 433 MHz, and vehicle wheel sensor apparatus 100 may transmit its unique identifier, wheel position, and measurement at one or more of those frequencies to wirelessly update monitoring system 101. In some embodiments, vehicle wheel sensor apparatus 100 updates (at 414) monitoring system 101 by performing a discovery or pairing procedure and/or by establishing a wireless network connection to monitoring system 101 before transmitting the data updates to monitoring system 101.

In response to receiving the updates, monitoring system 101 may self-calibrate in order to record the measurement data from each vehicle wheel sensor apparatus 100 at the correct wheel position and/or to update a diagnostic display with the measurements in the correct locations. For instance, the vehicle dashboard may be configured to provide a real-time display of the tire pressure at each wheel location. After a tire rotation, monitoring system 101 may update the real-time display to display the received tire pressure measurements from each vehicle wheel sensor apparatus 100 at the wheel position detected by each vehicle wheel sensor apparatus 100 without a user having to manually enter the wheel positions and/or calibrate monitoring system 101.

The data collected by vehicle wheel sensor apparatuses 100 may be tracked over the lifetime of a tire and/or vehicle. The historical data may be used to verify or validate warranty coverage, automatically report on the vehicle maintenance history, and/or provide maintenance reminders to the vehicle owner. For instance, tires typically come with a warranty for the expected life of the tire. If the tire fails before its expected life or does not last for the warranted mileage, the tire manufacturer may reimburse the vehicle owner for the difference in the actual tire life and the expected life. However, many such warranties are conditioned on proper tire maintenance. In particular, if tire rotations are not performed according to the manufacturer specified schedule, the manufacturer may void the warranty, deny coverage, or reduce coverage. Users may not document every tire rotation that is performed, may visit different repair or maintenance shops for different tire rotations, or may perform their own rotations that are not documented at a certified repair shop such that the complete record of tire rotations is not available at one location. Vehicle wheel sensor apparatuses 100 may resolve these issues for the vehicle owner, repair or maintenance shops, the tire manufacturers, and/or the vehicle manufacturer by automatically tracking the tire rotations and/or other maintenance performed on the wheels. The service record may be stored locally in the memory of each vehicle wheel sensor apparatus 100, monitoring system 101, and/or in the cloud.

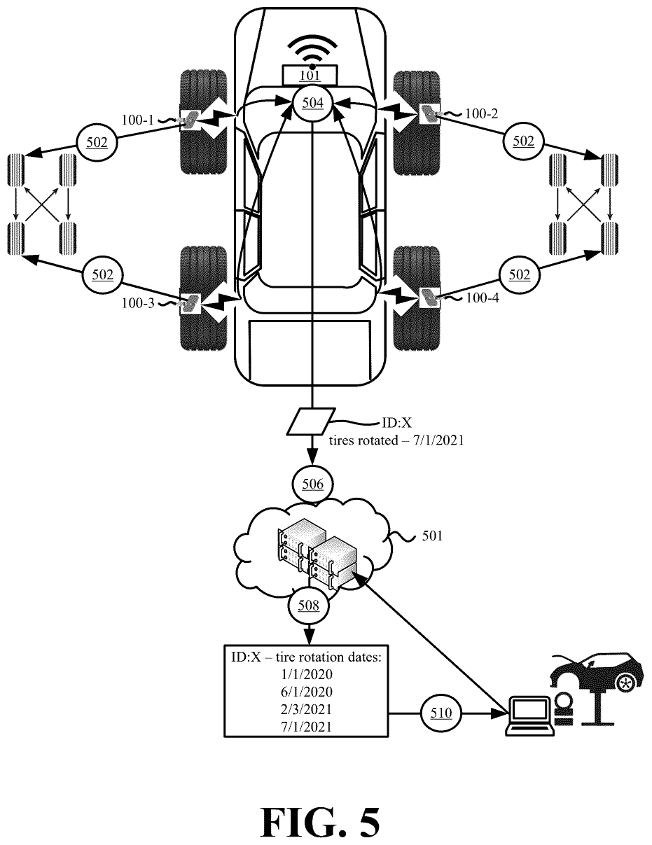

FIG. 5 illustrates an example of automatically tracking vehicle maintenance using vehicle wheel sensor apparatuses 100 in accordance with some embodiments presented herein. Vehicle wheel sensor apparatuses 100 may detect (at 502) when there is change to their respective position on a vehicle due to a tire rotation or other maintenance that involves changing the tire or wheel positions. For instance, vehicle wheel sensor apparatuses 100 may track in local memory or storage a current position. When vehicle wheel sensor apparatuses 100 detect (at 502) a new or changed position, they may record the date or may notify (at 504) monitoring system 101 of the changed position and monitoring system 101 may record the date at which the tire positions changed as an indication of a tire rotation.

Monitoring system 101 may periodically upload (at 506) or transmit the recorded maintenance or tire rotation dates to cloud site 501. In some embodiments, monitoring system 101 is configured or programmed with the network address and credentials to access and report to cloud site 501.

Monitoring system 101 may upload or transmit the detected tire rotations to cloud site 501 when a new tire rotation is detected or on a timed basis (e.g., once a month). Monitoring system 101 may upload or transmit the data using the vehicle's wireless connectivity. In some embodiments, the data is downloaded from monitoring system 101 to a repair shop device whenever the vehicle is taken in for maintenance, and the repair shop device may automatically upload or transmit the data to cloud site 501. In still some other embodiments, monitoring system 101 may connect to a user device using short-range wireless connectivity and the user device may upload or transmit the data from vehicle wheel sensor apparatuses 100 to cloud site 501.

Cloud site 501 receives (at 506) the uploaded data which includes one or more of the vehicle identification number (VIN) or the unique identifiers of vehicle wheel sensor apparatuses 100 that generated the data and the data that was recorded or measured (e.g., date of a tire rotation and/or tire pressures at the time of rotation). Cloud site 501 associates the uploaded (at 506) data to a particular vehicle based on the provided VIN or the unique identifiers. For instance, the unique identifiers of vehicle wheel sensor apparatuses 100 may be associated with a particular VIN by the vehicle manufacturer when the vehicle is assembled or whenever the vehicle wheels are changed, and the data is provided cloud site 501 for record tracking.

Cloud site 501 creates a vehicle profile based on the provided VIN or the unique identifiers if one does not exist and enters (at 508) the uploaded (at 506) data to the correct vehicle profile. The vehicle profile tracks all tire rotations performed on a vehicle and the respective dates regardless of the tire rotations being performed at different repair or maintenance shops or by the vehicle owner.

Cloud site 501 may provide (at 510) the tire rotation history to verify or validate a tire warranty claim. Specifically, the tire rotation history may be used to verify that the tire did not last for the warrantied life despite being properly maintained. The tire rotation history may be made available to a tire shop that replaces the vehicle tires or to the tire manufacturer. For instance, the tire shop may issue a request to cloud site 501 for the tire rotation history with the vehicle VIN, and cloud site 501 may return the tracked record of tire rotations.

In some embodiments, vehicle wheel sensor apparatuses 100 include a non-volatile storage that tracks each tire positional change. In some such embodiments, the tire rotation history may be downloaded directly from vehicle wheel sensor apparatuses 100.

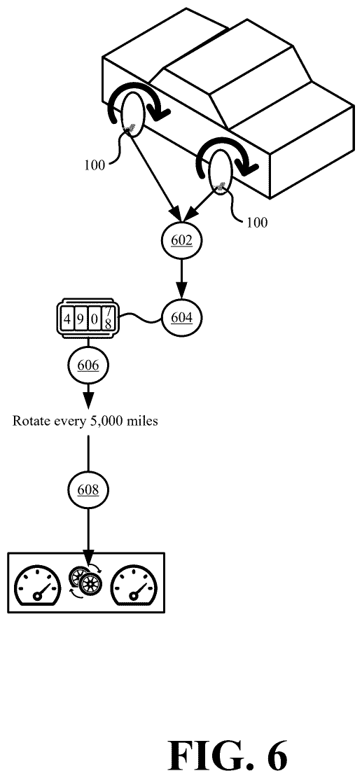

FIG. 6 illustrates an example of providing service reminders based on the tracking performed by vehicle wheel sensor apparatuses 100 in accordance with some embodiments presented herein. Vehicle wheel sensor apparatuses 100 may be configured with the diameter of a tire and may track (at 602) each rotation of the tire using its IMU, accelerometer, and/or other sensors. Vehicle wheel sensor apparatuses 100 may track (at 604) a number of miles traveled on the tire since a last rotation or positional change based on the tire diameter and the number of tire rotations.

Vehicle wheel sensor apparatuses 100 may detect when the mileage reaches or approaches the mileage for a next tire rotation (e.g., every 5,000 miles) or may report the mileage to monitoring system 101 that detects when the mileage reaches or approaches the mileage for a next tire rotation. In response to determining (at 606) that the tracked mileage reaches or approaches the mileage for a next tire rotation, monitoring system 101 may generate (at 608) an alert on the vehicle dashboard to notify the user to go in for a tire rotation. Alternatively, monitoring system 101 may send an alert to an application that is associated with the vehicle and that runs on a user device. For instance, application may be used to remotely access various vehicle features (e.g., remote locking and unlocking of doors, turning engine on or off, etc.) and may also be used to provide service reminders to the user.

Moreover, monitoring system 101 may automatically turn off the alert on the vehicle dashboard once vehicle wheel sensor apparatuses 100 detect that the tires have been rotated removing another common annoyance. For instance, dashboard alerts are typically disabled once a mechanic or service personnel connects a device to monitoring system 101 and sends the command to disable the alert or as a result of the user navigating through various infotainment screens and holding down a button on the appropriate screen to disable the alert.

The driving characteristics that are tracked by vehicle wheel sensor apparatuses 100 may provide additional safety warnings or notifications for the vehicle. For instance, vehicle wheel sensor apparatuses 100 may measure wheel alignment while the vehicle is in motion. Severe misalignment may cause the vehicle to not respond safely at high speeds or sudden turns. Severe misalignment may also cause the tires to fail at an accelerated rate. Vehicle wheel sensor apparatuses 100 may report the misaligned wheels to monitoring system 101 and monitoring system 101 may generate an alert on the vehicle dashboard or on a user device to take the vehicle in for alignment.

In addition to the automated tracking and alerting, vehicle wheel sensor apparatuses 100 may also simplify vehicle maintenance. Wheel alignment typically involves mounting wheel clamps with sensors onto the drive wheels of the vehicle to measure the wheel alignment. Additionally, reflectors would have to be placed in specific locations relative to the vehicle in order to measure the wheel alignment. However, vehicle wheel sensor apparatuses 100 allow the mechanic to forego the mounting of specialized equipment and the specific placement of the reflectors. Instead, the mechanic may obtain alignment readings directly from vehicle wheel sensor apparatuses 100 such that the wheel alignment may be performed without any equipment setup or other configuration.

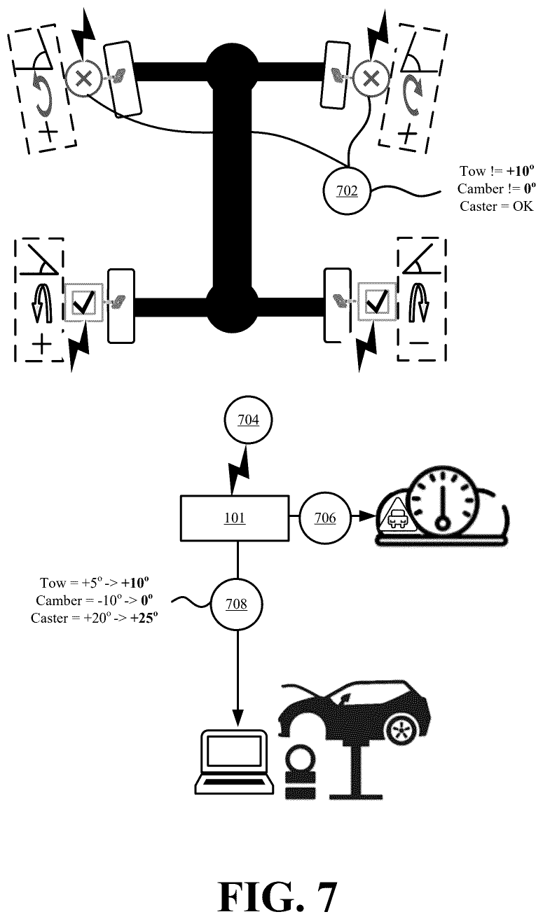

FIG. 7 illustrates an example of performing a zero-configuration wheel alignment using vehicle wheel sensor apparatuses 100 in accordance with some embodiments presented herein. The vehicle is brought to a maintenance shop in response to vehicle wheel sensor apparatuses 100 of the vehicle detecting and/or measuring (at 702) a wheel misalignment, reporting (at 704) the misalignment to monitoring system 101, and monitoring system 101 generating (at 706) an alert on the vehicle dashboard or the user device to take the vehicle in for alignment.

Vehicle wheel sensor apparatuses 100, via monitoring system 101 of the vehicle, provide (at 708) measurements associated with the wheel misalignment to a user device. For instance, the mechanic may connect their user device to monitoring system 101 using a wired or wireless connection and immediately obtain measurements for an amount or degree by which the wheel toe, caster, or camber deviates from manufacturer defined specification or tolerances. In some embodiments, vehicle wheel sensor apparatuses 100 measure the toe, caster, or camber deviations by measuring each wheel's arc-of-rotation or the tilt or orientation of each vehicle wheel sensor apparatus 100 while the vehicle is stationary or in motion. Since vehicle wheel sensor apparatuses 100 self-calibrate and determine their exact position on the vehicle, the measurements provided (at 708) to the user device identify which wheels are misaligned and by how much.

The mechanic may adjust the wheels according to the measurements or specific adjustments that are provided on the user device based on the measurements. In other words, the mechanic may immediately begin adjusting the wheels based on the prior measurements recorded by vehicle wheel sensor apparatuses 100 without the mechanic having to mount any equipment on the wheels, place reflectors, and/or perform their own tests to measure the misalignment for themselves.

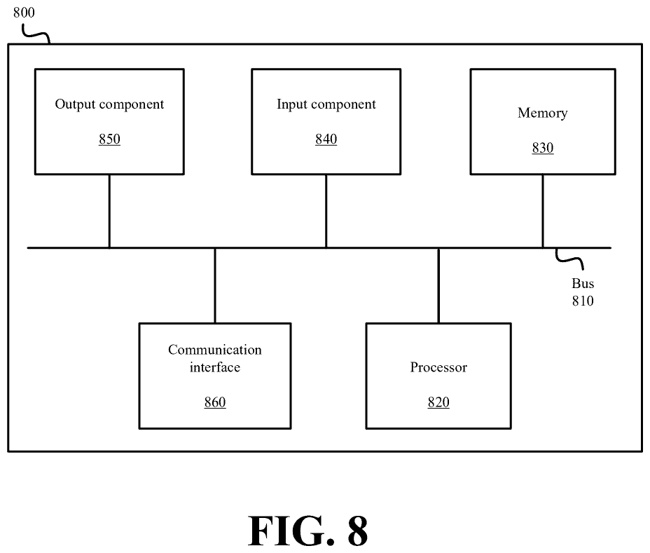

FIG. 8 is a diagram of example components of device 800. Device 800 may be used to implement one or more of the devices or systems described above (e.g., vehicle wheel sensor apparatuses 100, monitoring system 101, etc.). Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more light emitting diodes (LEDs), etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
exchanging wireless signaling between a particular vehicle wheel sensor apparatus that is integrated in a first wheel of a vehicle and other vehicle wheel sensor apparatuses that are integrated in other wheels of the vehicle ;
determining a relative position of the particular vehicle wheel sensor apparatus on the vehicle based on different directions or different distances that the particular vehicle wheel sensor apparatus measures from the wireless signaling exchanged with the other vehicle wheel sensor apparatuses;
determining an exact position of the particular vehicle wheel sensor apparatus on the vehicle based on the relative position and an additional input that identifies a front of the vehicle;
obtaining a measurement of the first wheel using the particular vehicle wheel sensor apparatus; and
updating a monitoring system of the vehicle with the exact position of the particular vehicle wheel sensor apparatus and the measurement that is obtained at that exact position.

2. The method of claim 1 further comprising:
wirelessly transmitting the measurement from the particular vehicle wheel sensor apparatus to the monitoring system.

3. The method of claim 1 further comprising:
generating a user interface on a display of the vehicle that presents the measurement at the exact position on the vehicle.

4. The method of claim 1 further comprising:
measuring a distance or a direction at which signaling from each of the other vehicle wheel sensor apparatuses arrives at the particular vehicle wheel sensor apparatus based on one or more of a time of flight or time difference of arrival associated with the signaling.

5. The method of claim 1 further comprising:
generating an alert on a display of the vehicle in response to the measurement deviating from an expected value or an expected range of values.

6. The method of claim 1 further comprising:
detecting that the particular vehicle wheel sensor apparatus is integrated in a front wheel of the vehicle based on a side-to-side movement of the first wheel that is detected by one or more sensors of the particular vehicle wheel sensor apparatus.

7. The method of claim 1 further comprising:
detecting that the particular vehicle wheel sensor apparatus is integrated in a front wheel of the vehicle based on signaling received from a user device and the signaling from the user device arriving at an opposite direction than the signaling from the other vehicle wheel sensor apparatuses.

8. The method of claim 1 further comprising:
detecting that the particular vehicle wheel sensor apparatus is integrated in a front wheel of the vehicle based on a direction of a rotation of the first wheel while the vehicle is in motion being in a first direction and the wireless signaling from the other vehicle wheel sensor apparatuses arriving in a different second direction.

9. The method of claim 1,
wherein obtaining the measurement comprises measuring a tire pressure of the first wheel; and
wherein updating the monitoring system comprises modifying a tire pressure readout to present the tire pressure of the first wheel at the exact position of the particular vehicle wheel sensor apparatus on the vehicle.

10. The method of claim 1 further comprising:
detecting that the exact position of the particular vehicle wheel sensor apparatus changes from a first position on the vehicle to a second position on the vehicle after a tire rotation.

11. The method of claim 10 further comprising:
providing an update to the monitoring system to associate the measurement to the second position on the vehicle.

12. The method of claim 10 further comprising:
modifying a diagnostic display of the vehicle to move the measurement from the first position to the second position on the vehicle in response to detected that the exact position changes.

13. The method of claim 10 further comprising:
recording a date of the tire rotation in response detecting that the exact position changes.

14. The method of claim 1, wherein obtaining the measurement comprises:
tracking a number of times the first wheel rotates; and
determining a mileage on the first wheel based on the number of times the first wheel rotates.

15. The method of claim 14, wherein updating the monitoring system comprises:
generating a service reminder notification in response to the mileage reaching a threshold mileage.

16. A particular vehicle wheel sensor apparatus that is integrated in a first wheel of a vehicle, the particular vehicle wheel sensor apparatus comprising:
a plurality of sensors;
a transceiver that receives wireless signaling from other vehicle wheel sensor apparatuses that are integrated in other wheels of the vehicle; and
one or more processors configured to:
determine a relative position of the particular vehicle wheel sensor apparatus on the vehicle based on different directions or different distances that the particular vehicle wheel sensor apparatus measures from the wireless signaling received from the other vehicle wheel sensor apparatuses;
determine an exact position of the particular vehicle wheel sensor apparatus on the vehicle based on the relative position and an additional input that identifies a front of the vehicle;
obtain a measurement of the first wheel using one or more of the plurality of sensors; and
update a monitoring system of the vehicle with the exact position of the particular vehicle wheel sensor apparatus and the measurement that is obtained at that exact position.

17. The particular vehicle wheel sensor apparatus of claim 16, wherein the one or more processors are further configured to:
wirelessly transmit the measurement to the monitoring system using the transceiver.

18. The particular vehicle wheel sensor apparatus of claim 16, wherein the one or more processors are further configured to:
measure a distance or a direction at which signaling from each of the other vehicle wheel sensor apparatuses arrives at the particular vehicle wheel sensor apparatus based on one or more of a time of flight or time difference of arrival associated with the signaling.

19. The particular vehicle wheel sensor apparatus of claim 16,
wherein obtaining the measurement comprises measuring a tire pressure of the first wheel; and
wherein updating the monitoring system comprises modifying a tire pressure readout to present the tire pressure of the first wheel at the exact position of the particular vehicle wheel sensor apparatus on the vehicle.

20. The particular vehicle wheel sensor apparatus of claim 16, wherein the one or more processors are further configured to:
detect that the exact position of the particular vehicle wheel sensor apparatus changes from a first position on the vehicle to a second position on the vehicle after a tire rotation; and
recording a date of the tire rotation in response detecting that the exact position changes.
